(19) United States
(12) Patent Application Publication
(10) Pub. No.: US 2018/0013706 A1
(43) Pub. Date: Jan. 11, 2018

(54) SYSTEM AND METHOD FOR CENSORING OF COMMENTS MADE ON SOCIAL MEDIA

(71) Applicant: Karma Wiki Co., Walnut, CA (US)

(72) Inventors: Clyde Rathbone, Kingston (AU); Dayne Rathbone, Kingston (AU)

(73) Assignee: Karma Wiki Co., Walnut, CA (US)

(21) Appl. No.: 15/641,938

(22) Filed: Jul. 5, 2017

(30) Foreign Application Priority Data
Jul. 6, 2016 (AU) 2016902648

(51) Int. Cl. H04L 12/58; H04L 29/08

(52) U.S. Cl. CPC H04L 51/12; H04L 51/32; H04L 67/306

(57) ABSTRACT

The present disclosure includes systems and methods for censoring comments made on social media. A censorship list associated with a subject user may be maintained, wherein the censorship list comprises a plurality of censored comments associated with the subject user. A commenting user may publish a comment on the wall of the subject user. The subject user may be notified on the comment, and provided an option as to whether to censor the comment. The comment may be added to the censorship list if the subject user censors the comment.

This application claims priority under 35 U.S.C. §119 to Australian patent application 2016902648, filed Jul. 6, 2016, the disclosure of which is incorporated herein by reference.

### FIELD OF THE INVENTION

One or more embodiments relate to systems and methods for providing media content to multiple users. More specifically, one or more embodiments of the present disclosure relate to systems and methods for censoring of comments made on social media.

### BACKGROUND OF THE INVENTION

Through advancements in computing devices and computing technology, users can often share user-generated content with other users. For instance, a user can share user-generated content with a group of friends via a variety of communication systems (e.g., IM, text, or social networks).

Social networks and online platforms that enable people to comment and review businesses and services are well known in the art. For example, websites like TripAdvisor allows users to comment on and rate a company or service. Such systems have the ability to allow other users to agree or disagree with the original commenter's remarks thereby adding weight to the commenter's position, or if in disagreement reducing its weight of opinion amongst the community of users.

Despite advances in technology, a number of drawbacks remain for a user wanting to vote or comment about individuals rather than companies or services. Legal issues such as privacy laws, defamation, and libel apply when a person is the subject of another person's opinion involving voting and comments. Furthermore, while it is expected that some customers of a business may be dissatisfied or unhappy with a product or service, complaints against an individual must be much more respectfully and carefully handled.

This has led to a situation where no social networks to date have successfully been designed for the purpose of rating, reviewing, or commenting on individuals. A key factor in the success of such a social network would be the ability to allow the subject of a comment to easily censor or stop the publishing of a comment about them by another person. Yet no service to date has offered this capability.

Accordingly, there are a number of considerations to be made in improving a user experience in relation to commenting on and rating individuals.

### SUMMARY OF THE INVENTION

One or more embodiments described herein provide benefits and/or solve one or more of the foregoing or other problems in the art with systems and methods for censoring comments on social media. The present disclosure includes systems and methods for censoring comments made on social media. A censorship list associated with a subject user may be maintained, wherein the censorship list comprises a plurality of censored comments associated with the subject user. A commenting user may publish a comment on the profile page of the subject user. The subject user may be notified of the comment, and provided with an option to censor the comment. The comment may be added to the censorship list if the subject user censors the comment.

In some embodiments, the method further includes displaying the plurality of censored comments on the wall of the subject user. The censored comments could be displayed together with uncensored comments. Further embodiments include greying out part of the censored comments. Further embodiments including greying out part of the censored comments, but displaying some parts or meta-data about the comment (such as author, subject, comment title, comment score, date published, or date censored). Further embodiments include allowing a viewing user to contact or communicate with the author of a censored comment.

Embodiments of the present disclosure further include a scoring system, wherein a commenting user may assess either a subject user or comments on the subject user's wall via the scoring system. For example, in one embodiment a simple scoring system could be a simple agree, neutral or disagree selection or a five star selector. An alternative embodiment could use any score system including but not limited to thumbs up or thumbs down, a numeric value such as seventy out of a possible one hundred or a star system where the target person is given a score in terms of number of gold stars.

In some embodiments, each comment or post has an explicit subject such that the subject of a piece of content can be explicitly identified. In some embodiments, a user must be ID verified in order to write content, and to censor content written about them.

Additional features and advantages will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features of one or more embodiments can be obtained, a more particular description will be rendered by reference to specific embodiments thereof that are illustrated in the accompanying drawings. It should be noted that the figures are not drawn to scale, and that elements of similar structure or function are generally represented by like reference numerals for illustrative purposes throughout the figures. These drawings depict only typical embodiments, and are not therefore considered to be limiting of its scope. Accordingly, various embodiments will be described and explained with additional specificity and detail using the accompanying drawings.

FIG. 1 illustrates an exemplary social network environment in which a record of censorship can be maintained.

FIG. 2 illustrates a simple subject page layout according to an embodiment of the present disclosure.

FIG. 3 illustrates the details of the components of each comment shown on a user page according to an embodiment of the present disclosure.

FIG. 4 illustrates an example of a subject's page according to an embodiment of the present disclosure.

FIG. 5 illustrates an example of a commenter's published comments page according to an embodiment of the present disclosure.

FIG. 6 is a flow diagram of an exemplary process for censoring comments.

### DETAILED DESCRIPTION OF THE INVENTION

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Embodiments disclosed herein provide benefits and/or solve one or more of the abovementioned or other problems in the art with systems and methods for censoring comments made on social networks. In particular, the system easily allows a user to receive, view, and censor comments on their social media page. Additionally, in one or more embodiments, the censorship system provides an intuitive graphical user interface that allows a user to efficiently navigate, view, create, censor, un-censor, and otherwise manage comments including censored comments and maintaining a record of censorship.

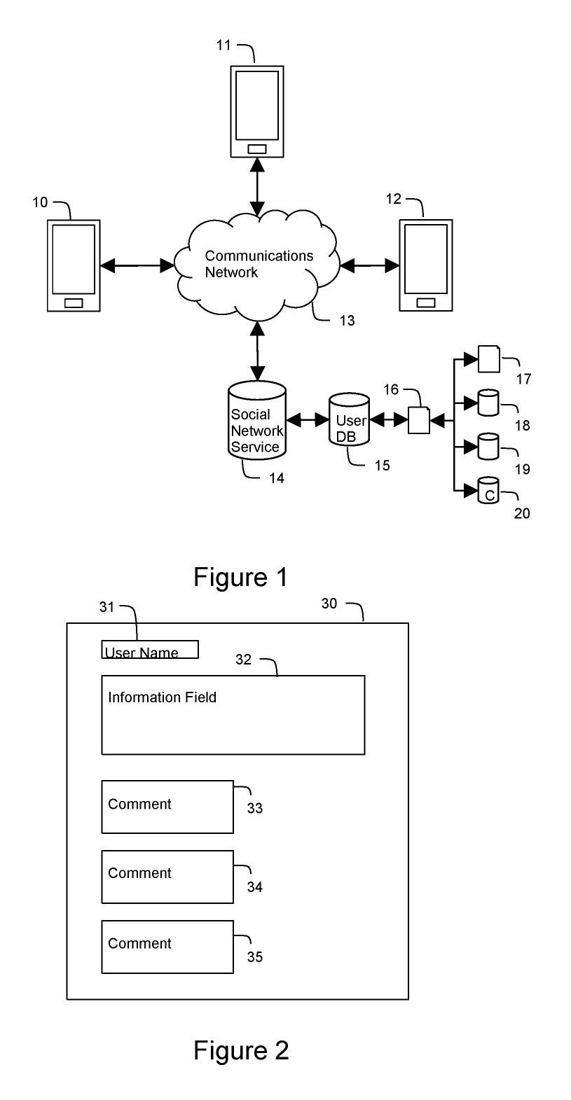

FIG. 1 illustrates an exemplary social network environment in which a record of censorship can be maintained. Users 10, 11, and 12 of a social network may connect over a communication network 13 such as the Internet to a social network service 14 that allows the users to comment about other parties. The social network service 14 may enable its users (such as persons or organizations) to interact with the system and with each other. The social networking system may, with input from a user, create and store in the social networking system a user profile associated with the user, or any other person or entity. In one embodiment the social networking system allows a user to create a profile page about someone who is not currently on the network. The user profile may include demographic information, communication-channel information, and information on personal interests of the user. Also, the social networking system may allow users to post comments and other multimedia content items to a user's profile page (typically known as “wall posts” or “feed”), both of which may be accessible to other users of the social networking system depending upon the user's configured privacy settings.

Additionally or alternatively, the communications network 13 may comprise an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the network may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communications network 13 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

In an example of the system, in reviewing comments made by others, a user 12 could agree or disagree with the comments made by a user 11 about another user 10 who may or may not be a member of the social network.

The social network service 14 typically includes a user management database 15 where a user's account 16 may have connected to it a number of related pieces of information. For example, a user may have a subject page 17 linked to their account 16.

Furthermore, the account 16 may be linked to a database of comments made by others about the user's own page 17 where the subject user of account 16 has chosen to censor those user's comments so that they are not viewable by other users and or the public. Comments 18, 19, and 20 are examples of comments linked to account 16. Comments 18 and 19 are uncensored comments, and comment 20 is a censored comment.

An example of this system in action would be where a user 10 has a page 17 where another user 11 has made a strongly disparaging comment about the user 10 and published it on the social network system 14. The target user 10 becomes aware of the disparaging comment made by user 11 and decides to censor the comment by having it blocked from view from the comments listing on the user's page 17. In some embodiments, each comment or post has an explicit subject such that the subject user or entity of a piece of content can be identified.

In some embodiments, a user must be ID verified in order to write content, and to censor content written about them. For example, a user can be manually verified by a moderator of the system by reviewing the attributes of their linked social media accounts. Alternatively, a user can be required to take a photo through a webcam and ensure it matches their driver's license. One such system is the Jumio Netverify system for verifying identity. It can be appreciated that ID verifying users allows the system to match users to the content written about them, and therefore allows the system to limit the ability to censor a piece of content to, and only to, the subject of the content. In an alternative embodiment, a user can only censor comments on their page written by someone else, and not actually delete the comment. It can be appreciated that while deletion removes all public record of the comment, censorship may maintain some public information about the comment and the means of censorship.

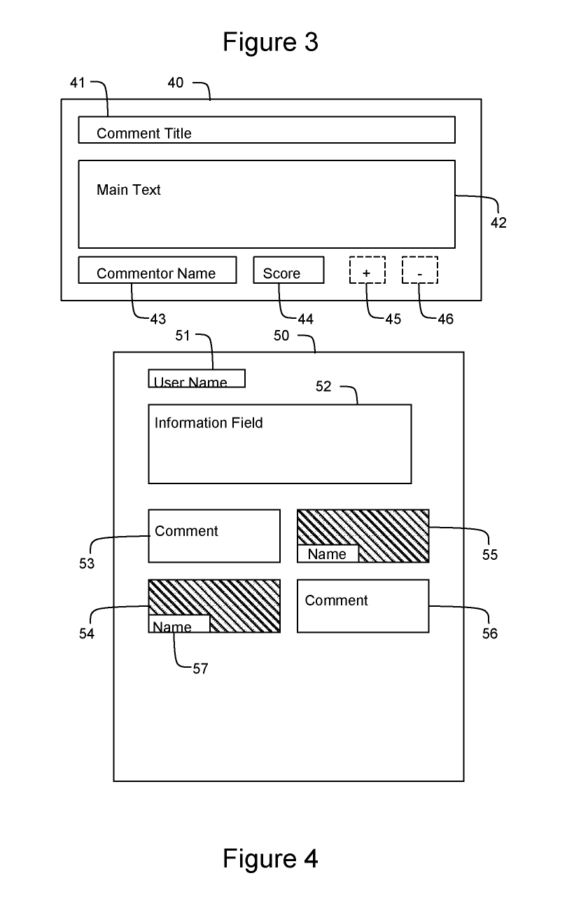

FIG. 2 discloses a simple subject page layout according to an embodiment of the present disclosure. The simplified page layout example 30 includes a name text area 31 and an information field 32 which includes information about the target person 31 of the page. Over time, other members of the service make comments 33, 34, and 35 relating to the person listed in name text area 31. Each of those comments 33, 34, and 35 come from individual users of the system. A more detailed explanation of the content of each comment is described in FIG. 3.

FIG. 3 discloses details of the components of each comment shown on a user page according to an embodiment of the present disclosure. A comment item 40 may include a comment title 41 which may be a short headline or summary of the sentiments expressed in the comment body text 42. In one embodiment, this main text 42 forms the majority of the user's comment item 40. In some embodiments, each comment or post explicitly defines the subject of the comment such that the name of the subject person or entity can be explicitly identified. For example, the title of a comment could be “Dayne Rathbone wrote a letter about Clyde Rathbone”. This title would be visible to everyone viewing the comment.

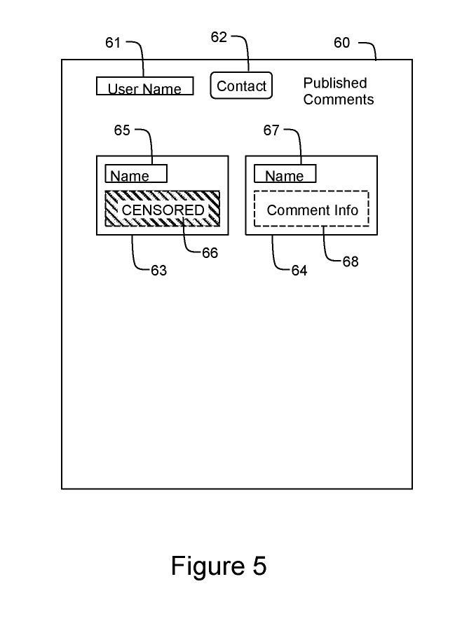

Also in the comment item 40 is the name of the commenter 43 who is the user that made the comment. In one embodiment, the commenter's name 43 also functions as a hyperlink that allows anyone viewing the comment 40 to link to the commenter's own page on the system. An example of a commenter's page according to an embodiment is described in FIG. 5.

In a further embodiment, the comment 40 may include a score 44 given by the commenter to quantitatively measure the commenter's opinion of the target entity. For example, a simple score 44 system could be a simple positive, neutral or negative selection or a five star selector. It can be appreciated that by providing a simple score for each user, the system provides an ability to learn about a person even if they have censored information such as comments about themselves. Vote buttons 45 and 46 allow other users who are not the subject of the page or the commenter to either agree (by pressing vote button 45 or disagree by pressing vote button 46) with the commenter's comment 42 or score 44. This example embodiment utilizes a scoring system 44 that simply uses a for, neutral or against assessment by the commenter with regard to the page subject. An alternative embodiment could use any score system including but not limited to thumbs up or thumbs down, a numeric value such as seventy out of a possible one hundred or a star system where the target person is given a score in terms of number of gold stars.

FIG. 4 illustrates an example of a subject's page according to an embodiment of the present disclosure. FIG. 4 shows a subject's page 50 as in FIG. 2, but also illustrates how comments could be censored as they are displayed on the page. The subject's page 50 features the subject's name 51 and related information 52, as explained FIG. 2. According to an embodiment of the present disclosure, comments 53, 54, 55, and 56 are added to the page as various users make the comments.

The comments are displayed as normal unless the subject person lays claim to the page and then chooses to censor the comments with which they disagree or otherwise have a problem with. That is, it is possible to write about someone before they have signed up to the platform. Only the owner of the page who is the subject of the page has the ability to censor comments. Thus, in this example, the censored comments 54 and 55 show as censored because they have been censored by the subject of page 50, and the headline, text, score and agree or disagree votes are greyed out or otherwise restricted from viewing.

In this example embodiment, the commenter's name 57 is allowed to be viewed. This is done in order to allow a user to link to the commenter's page 57. It can be appreciated by providing a link to the censored commenter's page 57, a third user would be able to contact the commenter to obtain further information about their comment. Thus, for example, a user can obtain accurate information about the subject's reputation while protecting the subject's right to privacy.

The example embodiment utilizes a censoring system that greys out disputed parts of a comment but allows a viewing user to still contact or communicate with the commenter. An alternative embodiment could notify the viewer of the fact that the comment has been censored using any technique including but not limited to simply using the text “Comment Censored”. Further, an alternative embodiment may not allow a viewing user to contact the commenter, however the example embodiment is designed to allow third parties to contact both of the parties involved in a disputed comment. Further, a censored comment may limit the display of any individual, combination or all comment related fields in each comment.

Existing social networks may allow users to mute comments from others so that the comments do not appear in the user's feed. However, this does not censor the message which can still be seen at other places in the network system. It can be appreciated that the example embodiment discussed above does not hide or mute comments entirely, because the public maintenance of a record of the censoring of comments has a value in signifying that a comment is disputed by the two parties (namely the subject and the commenter). That is, if a person's page has a lot of disputed and censored comments on their received page, then that can be an indicator of the consensus of sentiment for that subject or person in general.

FIG. 5 illustrates an example of a commenter's published comments page according to an embodiment of the present disclosure. In this embodiment, the commenter's page 60 would have the commenter's name 61 and an ability to contact the commenter 62. In a further embodiment, the ability to contact the commenter includes the ability to contact the commenter by means of email or phone text.

The commenter's page 60 also includes a listing of the comments 63 and 64 made by the commenter 61 and whether any of the comments have been censored. In this example, comment 63 has been censored, however comment 64 has not been censored. Each comment includes the name 65 and 67 of the target the comment.

In the case of censored comment 63. the comment title, text, score and agree or disagree vote are not displayed but replaced with a greyed out area and a notice 66 that says that the comment has been censored. In the case of a non-censored comment 64 the comment title, text, score and agree or disagree score are displayed as comment info 68.

It can be appreciated that if commenter's published comments shows that a large number of the commenter's comments are censored, then that it gives an indicator of the kind of comments the commenter is making.

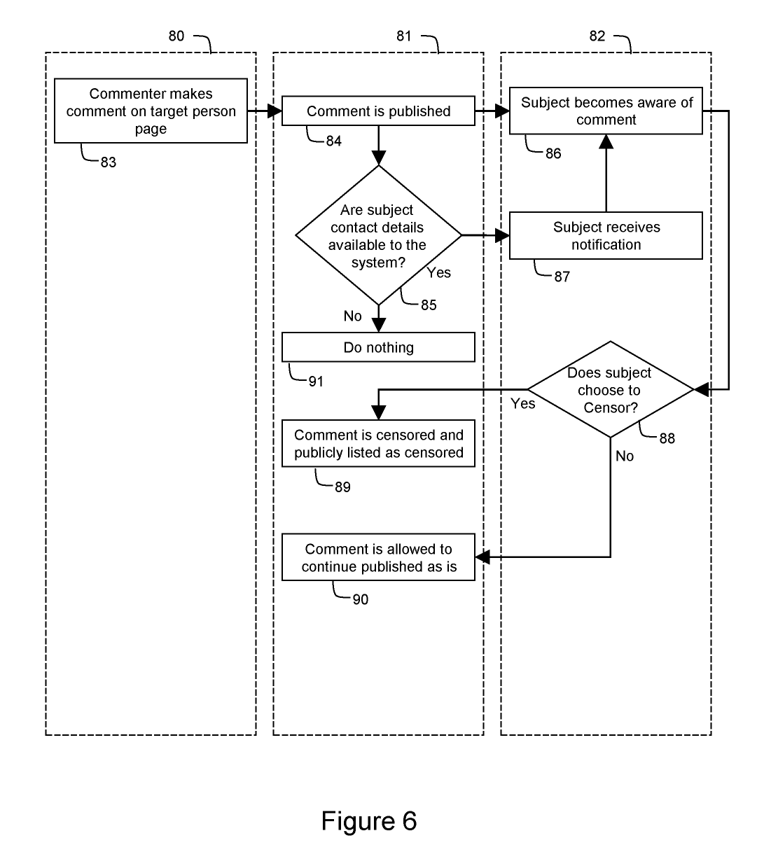

FIG. 6 is a flow diagram of an exemplary process for censoring comments.

In step 83, a commenter 80 makes a comment on a target person's page. In step 84, the system 81 publishes the comment. In step 85, if the subject of the comment or the owner of the subject page has supplied contact information then process jumps to step 87 where the page subject or owner is notified. If the page subject or owner has not supplied contact details 85 then the process goes to step 91 and does nothing.

In step 86, the subject or page owner becomes aware of the comment, either directly due to notice from the step 87 or otherwise, and the process proceeds to step 88.

In step 88, the owner of the subject page is given the ability to choose if they wish to censor the message. If the owner of the subject page chooses to censor the comment, the process goes to step 89 and the system publicly lists the comment as censored. If the owner of the subject page chooses not to censor the comment, then the system 81 allows the comment to continue to be published as normal in step 90.

One or more aspects of the present disclosure are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

In addition to the above, one or more aspects of the present disclosure may be provided, offered, deployed, managed, serviced, etc. by a service provider who offers management of customer environments. For instance, the service provider can create, maintain, support, etc. computer code and/or a computer infrastructure that performs one or more aspects of the present disclosure for one or more customers. In return, the service provider may receive payment from the customer under a subscription and/or fee agreement, as examples. Additionally or alternatively, the service provider may receive payment from the sale of advertising content to one or more third parties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiment with various modifications as are suited to the particular use contemplated.

Although the present disclosure has been described in relation to particular embodiments thereof, many other variations and modifications will become apparent to those skilled in the art. As such, it will be readily evident to one of skill in the art based on the detailed description of the presently preferred embodiment of the system and method explained herein, that different embodiments can be realized.

1. A method comprising:
maintaining a censorship list associated with a subject user, wherein the censorship list comprises a plurality of censored comments associated with the subject user;
publishing, by at least one processor, a comment made by a commenting user via a first client device on a wall of the subject user;
notifying the subject user via a second client device; and
providing the subject user an option to censor the comment.

2. The method of claim 1, further comprising adding the comment to the censorship list if the subject user censors the comment.

3. The method of claim 2, further comprising displaying the plurality of censored comments in the censorship list associated with the subject user on the wall of the subject user.

4. The method of claim 3, further comprising greying out parts of the plurality of censored comments.

5. The method of claim 4, further comprising allowing a viewing user to contact or communicate with a commenting user associated with a censored comment displayed on the wall of the subject user.

6. The method of claim 2, further comprising notifying the commenting user if the comment has been censored.

7. The method of claim 2, further comprising implementing a scoring system, wherein the commenting user assesses the subject user on the scoring system.

8. The method of claim 6, wherein the assessment comprises a vote for or against the subject user.

9. A non-transitory computer readable medium storing instructions thereon that, when executed by at least one processor, cause a computer system to:
maintain a censorship list associated with a subject user, wherein the censorship list comprises a plurality of censored comments associated with the subject user;
publish, by at least one processor, a comment made by a commenting user via a first client device on a wall of the subject user;
notify the subject user via a second client device; and
provide the subject user an option to censor the comment.

10. The non-transitory computer readable medium of claim 9, further comprising instructions that, when executed by the at least one processor, cause the computer system to add the comment to the censorship list if the subject user censors the comment.

11. The non-transitory computer readable medium of claim 10, further comprising instructions that, when executed by the at least one processor, cause the computer system to display the plurality of censored comments in the censorship list associated with the subject user on the wall of the subject user.

12. The non-transitory computer readable medium of claim 11, further comprising instructions that, when executed by the at least one processor, cause the computer system to grey out parts of the plurality of censored comments.

13. The non-transitory computer readable medium of claim 12, further comprising instructions that, when executed by the at least one processor, cause the computer system to allow a viewing user to contact or communicate with a commenting user associated with a censored comment displayed on the wall of the subject user.

14. The non-transitory computer readable medium of claim 10, further comprising instructions that, when executed by the at least one processor, cause the computer system to notify the commenting user if the comment has been censored.

15. The non-transitory computer readable medium of claim 10, further comprising instructions that, when executed by the at least one processor, cause the computer system to implement a scoring system, wherein the commenting user assesses the subject user on the scoring system.

16. The non-transitory computer readable medium of claim 13, wherein the assessment of the commenting user comprises a thumbs up or a thumbs down.
